(19) United States
(12) Patent Application Publication
(10) Pub. No.: US 2013/0249929 A1
(43) Pub. Date: Sep. 26, 2013

(54) STORAGE MEDIUM HAVING STORED THEREIN DISPLAY CONTROL PROGRAM, DISPLAY CONTROL APPARATUS, DISPLAY CONTROL SYSTEM, AND DISPLAY CONTROL METHOD

(71) Applicant: Junya OSADA, Kyoto-shi (JP)

(72) Inventor: Junya OSADA, Kyoto-shi (JP)

(21) Appl. No.: 13/561,816

(22) Filed: Jul. 30, 2012

(30) Foreign Application Priority Data
Mar. 23, 2012 (JP) 2012-066549

(51) Int. Cl. G09G 5/02; G09G 5/00

(52) U.S. Cl. 345/589; 345/581

(57) ABSTRACT

Data including character information is acquired from another apparatus, and a visual attribute of, when at least characters representing the character information displayed on a display apparatus, the characters is set by changing the visual attribute in accordance with an elapse of time. Then, the characters representing the character information are displayed on the display apparatus on the basis of the set visual attribute.

### CROSS REFERENCE TO RELATED APPLICATION

The disclosure of Japanese Patent Application No. 2012-66549, filed on Mar. 23, 2012, is incorporated herein by reference.

### FIELD

The technique shown here relates to a storage medium having stored therein a display control program, a display control apparatus, a display control system, and a display control method, and in particular, relates to a storage medium having stored therein a display control program that, for example, displays characters based on a user input, and a display control apparatus, a display control system, and a display control method that, for example, display characters based on a user input.

### BACKGROUND AND SUMMARY

Conventionally, a service termed “chat” is provided in which users exchange messages as character information via a network. When the chat is conducted, on a display screen of a terminal apparatus used by each user, messages are displayed that have been exchanged using the chat and include a message stated by the user themselves. Then, the user can newly generate and state a message by viewing the messages displayed on the display screen, thereby sequentially updating the messages on the display screen using the stated messages.

It is, however, often difficult to understand at what time the messages displayed on the display screen have been generated (the newnesses of the messages). Particularly in the form where a particular user group uses the same chat service, and message display areas for the users are fixedly displayed, the contents of the statements made by the users are easy to understand, but the newnesses of the messages (for example, the times when the messages have been stated) are difficult to understand.

Therefore, it is a main object of an exemplary embodiment to provide a storage medium having stored therein a display control program capable of facilitating the understanding of the newness of character information displayed as a result of exchanges among users, and a display control apparatus, a display control system, and a display control method that are capable of facilitating the understanding of the newness of character information displayed as a result of exchanges among users.

To achieve the above object, the exemplary embodiment can employ, for example, the following configurations. It should be noted that it is understood that, to interpret the descriptions of the claims, the scope of the claims should be interpreted only by the descriptions of the claims. If there is a conflict between the descriptions of the claims and the descriptions of the specification, the descriptions of the claims take precedence.

In an exemplary configuration of a computer-readable storage medium having stored therein a display control program according to the exemplary embodiment, the display control program is executed by a computer of an apparatus for performing display on a display apparatus, and the display control program causes the computer to execute: acquiring data including character information from another apparatus; setting a visual attribute of, when at least characters representing the character information are displayed on the display apparatus, the characters by changing the visual attribute in accordance with an elapse of time; and performing control so as to display the characters representing the character information on the display apparatus on the basis of the set visual attribute.

On the basis of the above, characters are displayed such that the visual attribute of the characters is changed in accordance with an elapse of time. This makes it possible to facilitate the understanding of the newness of character information acquired from another apparatus and displayed.

In addition, the visual attribute may be set by changing the visual attribute such that, when displayed on the display apparatus, the characters become difficult to view in accordance with the elapse of time.

On the basis of the above, a user can intuitively recognize the newness of the character information.

In addition, the visual attribute may be set by: changing the visual attribute until a predetermined time elapses such that, when displayed on the display apparatus, the characters gradually become difficult to view at least with the characters being visible; and, after the predetermined time elapses, maintaining the visual attribute set at the elapse of the predetermined time.

On the basis of the above, even if characters representing character information having a relatively long elapse of time are displayed, the viewing of the characters is always ensured. This makes it possible to prevent the situation where the character information does not reach other users.

In addition, a brightness of the characters when displayed on the display apparatus may be set as the visual attribute by changing the brightness in accordance with the elapse of time. The characters representing the character information may be displayed on the display apparatus on the basis of the set brightness.

On the basis of the above, the brightness of the characters representing the character information to be displayed is changed. This enables an intuitive recognition of the newness of the character information.

In addition, a color of the characters when displayed on the display apparatus may be set as the visual attribute by changing the color of the characters in accordance with the elapse of time. The characters representing the character information may be displayed on the display apparatus on the basis of the set color of the characters.

On the basis of the above, the color of the characters representing the character information to be displayed is changed. This enables an intuitive recognition of the newness of the character information.

In addition, a size of the characters when displayed on the display apparatus may be set as the visual attribute by changing the size of the characters in accordance with the elapse of time. The characters representing the character information may be displayed on the display apparatus on the basis of the set size of the characters.

On the basis of the above, the size of the characters representing the character information to be displayed is changed. This enables an intuitive recognition of the newness of the character information.

In addition, a portion to be displayed with a first visual attribute and a portion to be displayed with a second visual attribute may be set in each of the characters when displayed on the display apparatus, and a ratio of the portion to be displayed with the first visual attribute and the portion to be displayed with the second visual attribute may be set by changing the ratio in accordance with the elapse of time. The characters representing the character information may be displayed on the display apparatus on the basis of the first visual attribute, the second visual attribute, and the ratio that have been set.

On the basis of the above, it is possible not only to recognize the newness of the character information, but also to roughly estimate the elapse of time on the basis of the ratio of the portions displayed with different visual attributes.

In addition, the elapse of time may be an elapse of time from a time when a user of said another apparatus inputs the character information to a present time.

On the basis of the above, it is possible to recognize the newness of the character information from the time when a user of said another apparatus inputs the character information.

In addition, the display control program may further cause the computer to execute: receiving an input from an input apparatus; and inputting characters on the basis of the input. In this case, a visual attribute of the input characters when displayed on the display apparatus may also be set by changing the visual attribute of the input characters in accordance with the elapse of time. The input characters may be displayed on the display apparatus on the basis of the set visual attribute.

On the basis of the above, even characters input by a user of the apparatus themselves are displayed such that the visual attribute of the characters is changed in accordance with the elapse of time. This makes it possible to facilitate the understanding of also the newness of the characters input by the user who is using the apparatus and displayed.

In addition, the exemplary embodiment may be carried out in the forms of a display control apparatus and a display control system that include units for performing the above processes, and a display control method including the above operations.

On the basis of the exemplary embodiment, characters are displayed such that the visual attribute of the characters is changed in accordance with an elapse of time. This makes it possible to facilitate the understanding of the newness of character information acquired from another apparatus and displayed.

These and other objects, features, aspects and advantages of the exemplary embodiment will become more apparent from the following detailed description of the exemplary embodiment when taken in conjunction with the accompanying drawings.

### BRIEF DESCRIPTION OF THE DRAWINGS

FIG. 1 is a diagram showing a non-limiting example of a display control system according to an exemplary embodiment;

FIG. 2 is a block diagram showing a non-limiting example of the configuration of a terminal apparatus 3 in FIG. 1;

FIG. 3 is a diagram showing a non-limiting example of an image displayed on a display section 35 in FIG. 2;

FIG. 4 is a diagram showing a non-limiting variation where the visual attribute of characters displayed on the display section 35 in FIG. 2 is changed;

FIG. 5 is a diagram showing non-limiting examples of main data and programs stored in a storage section 32 in FIG. 2; and

FIG. 6 is a flow chart showing a non-limiting example of the processing performed by the terminal apparatus 3 in FIG. 2.

### DETAILED DESCRIPTION OF NON-LIMITING EXAMPLE EMBODIMENTS

With reference to FIG. 1, a display control system according to an exemplary embodiment is described. As shown in FIG. 1, a display control system 1, which is an example of the display control system, is constructed by the connection between a plurality of terminal apparatuses 3 via a network 100.

Each of the terminal apparatuses 3 is configured to be connected to the network 100 using wireless or wireless communication. For example, the terminal apparatus 3 can execute a predetermined application (for example, a chat service) in combination with the other terminal apparatuses 3, using a peer-to-peer communication method, a client-server method, or the like. Alternatively, the terminal apparatus 3 may execute the predetermined application by establishing connection with a server (for example, a chat server) via the network 100. For example, the terminal apparatus 3 can execute a display control program stored in a storage medium such as an exchangeable optical disk, or received from another apparatus. The terminal apparatus 3 may be a device such as a general personal computer, a stationary game apparatus, a mobile phone, a handheld game apparatus, or a PDA (Personal Digital Assistant).

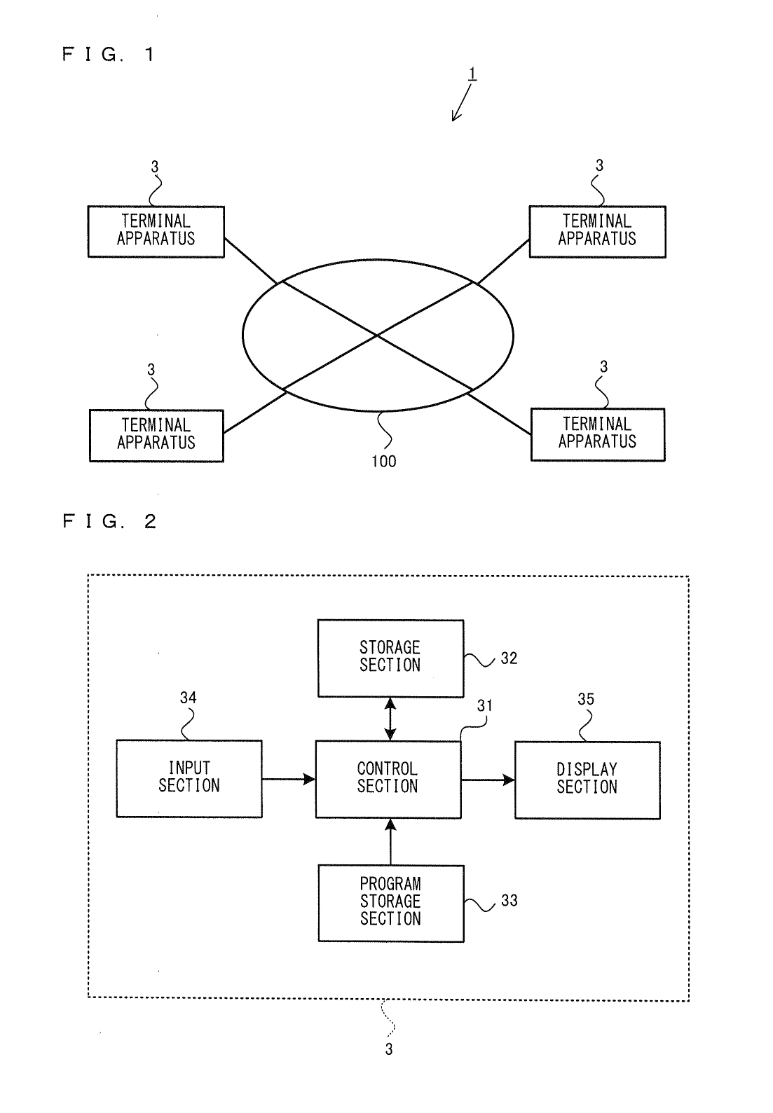

Next, with reference to FIG. 2, the terminal apparatus 3 is described. It should be noted that FIG. 2 is a block diagram showing an example of the configuration of the terminal apparatus 3. In FIG. 2, the terminal apparatus 3 includes a control section 31, a storage section 32, a program storage section 33, an input section 34, and a display section 35. The terminal apparatus 3 may be a single apparatus having the above components 31 through 35. Alternatively, the terminal apparatus 3 may include one or more apparatuses containing: an information processing apparatus having at least the control section 31; and another apparatus.

The control section 31 is information processing means (a computer) for performing various types of information processing, and is, for example, a CPU. The control section 31 has the functions of performing as the various types of information processing: the process of performing a chat service in which the terminal apparatus 3 exchanges character information with the other terminal apparatuses 3, and displaying the character information on the display section 35; processing based on the operation performed on the input section 34 by a user; and the like. The above functions of the control section 31 are achieved, for example, as a result of the CPU executing a predetermined program.

The storage section 32 stores various data to be used when the control section 31 performs the above information processing. The storage section 32 is, for example, a memory accessible by the CPU (the control section 31).

The program storage section 33 stores a program. The program storage section 33 may be any storage device (storage medium) accessible by the control section 31. For example, the program storage section 33 may be a storage device provided in the information processing apparatus having the control section 31, or may be a storage medium detachably attached to the information processing apparatus having the control section 31. Alternatively, the program storage section 33 may be a storage device (a server or the like) connected to the control section 31 via a network. The control section 31 (the CPU) may read some or all of the program to the storage section 32 at appropriate timing, and execute the read program.

The input section 34 is an input apparatus that can be operated (subjected to a character input operation performed) by the user. The input section 34 may be any input apparatus.

The display section 35 displays an image in accordance with an instruction from the control section 31.

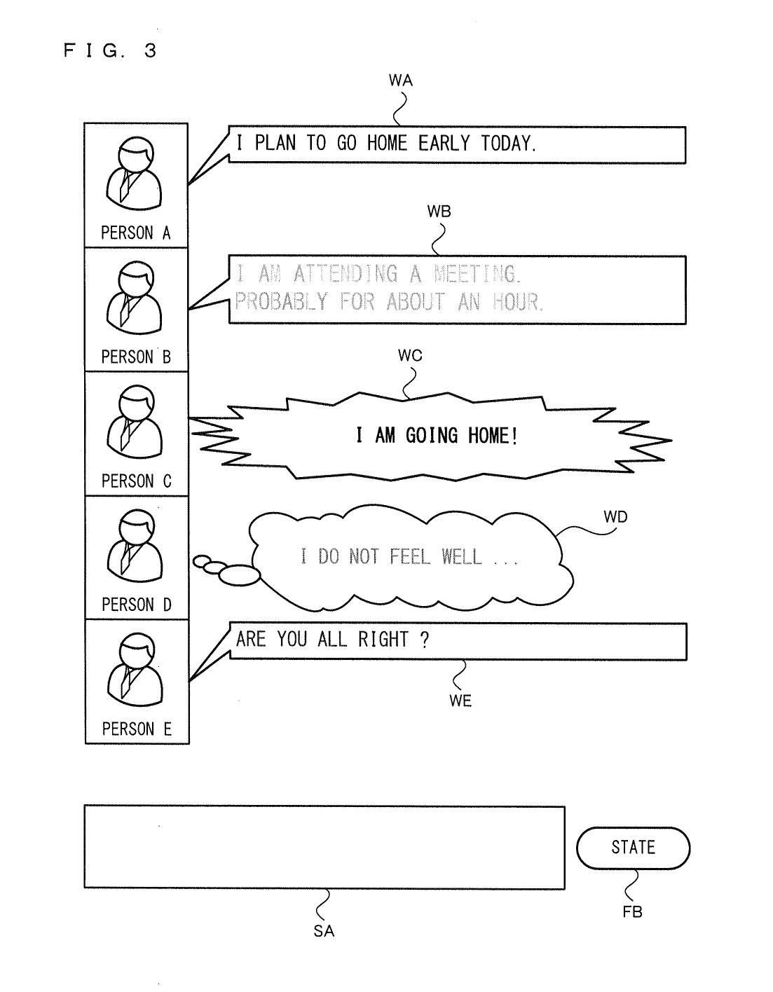

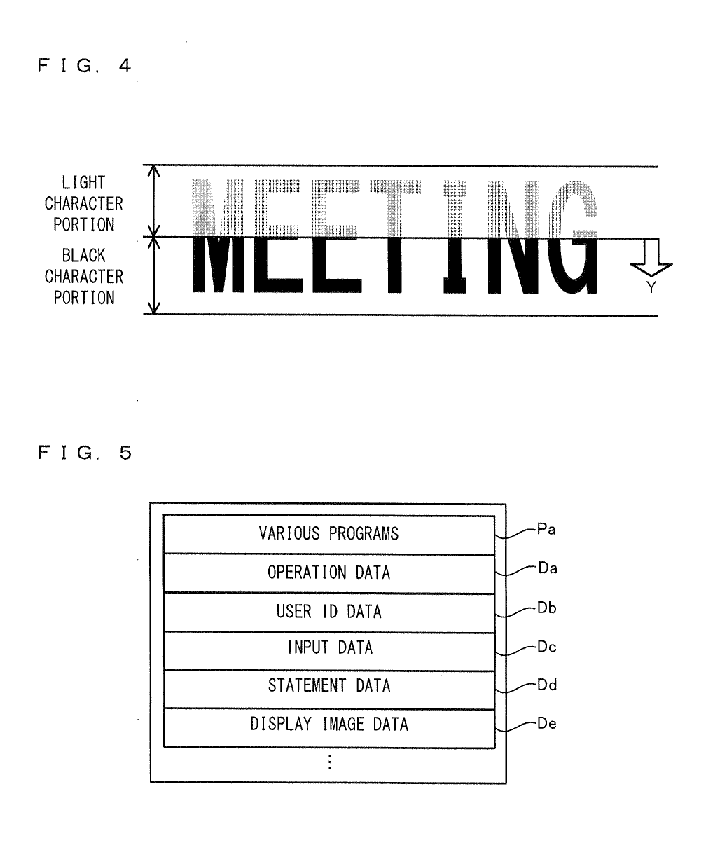

Next, with reference to FIGS. 3 and 4, a description is given of an overview of the processing performed by the terminal apparatus 3, before the description of specific processing performed by the terminal apparatus 3. It should be noted that FIG. 3 is a diagram showing an example of an image displayed on the display section 35 of the terminal apparatus 3. FIG. 4 is a diagram showing a variation where the visual attribute of characters displayed on the display section 35 is changed. It should be noted that the following descriptions are given using an example of character information that is displayed on the display section 35 by executing a display control program according to the exemplary embodiment when a chat service is used in which users of a particular user group exchange messages as character information.

As shown in FIG. 3, on the display section 35 of the terminal apparatus 3 used by a user belonging to the particular user group, the latest messages stated using the chat service by all the users are displayed. In the exemplary embodiment, areas are fixedly set where messages stated by the users are displayed. Specifically, in the example shown in FIG. 3, the users of the particular user group are a person A, a person B, a person C, a person D, and a person E. In this case, the person A is stating, “I plan to go home early today”, as a latest message WA; the person B is stating, “I am attending a meeting. Probably for about an hour”, as a latest message WB; the person C is stating, “I am going home!” as a latest message WC; the person D is stating, “I do not feel well . . . ”, as a latest message WD; and the person E is stating, “Are you all right?” as a latest message WE.

Here, the brightnesses of the colors of the characters of the messages WA through WE increase (the depths of the colors of the characters decrease) in accordance with the times elapsed since the statements of the respective messages WA through WE. For example, if display is performed such that the background color is white and the color of the characters of a message is black immediately after the statement of the message, the black changes to dark gray and subsequently, further changes to light gray, in accordance with the time elapsed since the statement of the message. As an example, in the example shown in FIG. 3, the messages WA and WC are displayed such that the colors of the characters of the messages are black, because it is immediately after the person A and the person C have stated the respective messages. Meanwhile, the message WE is displayed such that the color of the characters of the message is dark gray, because a certain time has elapsed since the person E stated the message. Further, the messages WB and WD are displayed such that the colors of the characters of the messages are light gray, because longer times have elapsed since the person B and the person D stated the respective messages. By thus viewing the color of the characters of a message stated by each user, it is possible to intuitively know the time elapsed since the user stated the message, that is, the newness of the stated message.

It should be noted that possible examples of the amount of change in the brightness of the color of the characters in accordance with the elapsed time include various forms. For example, the elapsed time and the brightness may be set so as to have a linear relationship (that is, the amount of change in the brightness is constant relative to an elapse of time per unit of time). Alternatively, the elapsed time and the brightness may have a curved relationship, such as a quadratic curve or a cubic curve, where the amount of change in the brightness gradually increases relative to the elapsed time or where the amount of change in the brightness gradually decreases relative to the elapsed time, or may have a stepwise and linear relationship. The brightness of the color of the characters that changes in accordance with the elapsed time may be set such that the upper limit of the brightness is a predetermined brightness that makes the characters visible to the user. A predetermined brightness that makes the characters visible to the user is thus set as an upper limit, whereby, even if a message having a relatively long elapsed time is displayed, the viewing of the message is always ensured. This makes it possible to prevent the situation where the message does not reach other users. It should be noted that it is needless to say that the above upper limit does not need to be set if it is not necessary to ensure the visibility of the message.

In addition, in the above example of the change in the color of the characters of a message, the difference in brightness between the background color and the color of the characters is greatest (as an example, the background is white and the characters are black) immediately after the statement of the message, and the difference in brightness decreases in accordance with the time elapsed thereafter. Thus, the message changes so as to be difficult to view. That is, the message becomes difficult to view, gradually or stepwise with the elapsed time. The brightness of the characters is thus changed such that the visibility of the message decreases gradually or stepwise, whereby the user can also intuitively recognize the newness of the message. Here, to make the message difficult to view with the elapsed time, as a possible example, the message in white characters may be displayed on a black background immediately after the statement of the message, and the brightness of the color of the characters of the message may decrease in accordance with the time elapsed thereafter. Also such a change form can be expected to produce similar effects. It should be noted that, if such effects are not desired, the brightness of the color of the characters of the message may change in accordance with the elapsed time in a manner opposite to the change form described above.

In addition, in the above example of the change in the color of the characters of a message, the brightness of the entirety of the characters is changed. Alternatively, the brightness of a part of the characters may be changed. For example, as shown in FIG. 4, the brightness of the characters may be changed such that, in the characters displayed in black immediately after the statement, a gray portion (a light character portion) gradually increases from the top of the characters in a direction Y shown in FIG. 4, in accordance with the elapsed time. As an example, the above change in the color of the characters can be achieved as follows. Black text and gray text that represent the same characters are prepared; in the gray text, the portion based on the ratio set as described above (the portion corresponding to a black character portion in the example shown in FIG. 4) is deleted from the bottom of the gray text in accordance with the elapsed time; and the gray text, of which the portion based on the above ratio has been deleted, is superimposed on the black text so as to have priority such that the same characters overlap each other. As another example, the above change in the color of the characters can be achieved as follows. In the black text, the portion based on the ratio set as described above (the portion corresponding to the light character portion in FIG. 4) is deleted from the top of the black text in accordance with the elapsed time; and the black text, of which the portion based on the above ratio has been deleted, is superimposed on the gray text so as to have priority such that the same characters overlap each other. By thus viewing the display ratio of the black character portion and the light character portion, it is possible not only to know the newness of the message represented by the characters, but also to roughly estimate the elapsed time of the message on the basis of the display ratio.

In addition, the above descriptions are given using the example where the brightness of the color of the characters of a message changes in accordance with the time elapsed since the statement of the message. Alternatively, another visual attribute may change so long as the appearance of the message changes in accordance with the elapsed time. For example, the saturation of the color of the characters, the hue of the color of the characters, or the size of the characters may be changed in accordance with the elapsed time. In these cases, it is possible to make the characters difficult to view by changing each visual attribute as follows. The saturation of the color of the characters is reduced; the hue of the color of the characters is changed from a color different from the background color to a color similar to the background color; or the size of the characters is reduced. It should be noted that, in the specification, the brightness, the saturation, and the hue of the color of the characters and the size of the characters are collectively referred to as the visual attribute of the characters. It is possible to obtain the effects described above by changing at least one of these visual attributes when the message is displayed.

In addition, in the above example, in accordance with the time elapsed from the time when each user has stated a message (has input the message), the visual attribute of the characters of the message when displayed is changed. Alternatively, an elapsed time based on another type of timing may be used. For example, display may be performed as follows. As an example, in accordance with the time elapsed from the time when each user has transmitted a message, the visual attribute of the characters of the message when displayed may be changed. As another example, in accordance with the time elapsed from the time when the terminal apparatus 3 for displaying a message has received the message, the visual attribute of the characters of the message when displayed may be changed. As yet another example, in accordance with, if a received message can be viewed after being opened, the time elapsed since the opening of the message, the visual attribute of the characters of the message when displayed may be changed.

Next, a detailed description is given of the processing performed by the terminal apparatus 3. First, with reference to FIG. 5, main data used in the processing is described. It should be noted that FIG. 5 is a diagram showing examples of main data and programs stored in the storage section 32 of the terminal apparatus 3.

As shown in FIG. 5, the following are stored in the data storage area of the storage section 32: operation data Da; user ID data Db; input data Dc; statement data Dd; display image data De; and the like. It should be noted that the storage section 32 may store, as well as the data shown in FIG. 5, data and the like necessary for the processing, such as data used in an application to be executed. Further, in the program storage area of the storage section 32, various programs Pa included in the display control program are stored.

The operation data Da is data representing the content of the operation performed on the input section 34.

The user ID data Db is data representing a unique code (a user ID) that enables the identification of the user who is using the terminal apparatus 3.

The input data Dc is data representing a message input by the user of the terminal apparatus 3 to make a statement to the other users. For example, the input data Dc includes character data representing the content of a message stated by the user and statement date/time data representing the date and time of the statement of the message, and includes at least data regarding the latest message.

The statement data Dd is data representing messages stated by the users of the other terminal apparatuses 3 and a message stated by the user of the terminal apparatus 3 themselves. For example, the statement data Dd includes character data representing the contents of messages stated by all the users and statement date/time data representing the dates and times of the statements of the respective messages, and includes at least data regarding the latest messages of all the users. The statement data Dd also includes data representing the states of the visual attributes of the characters representing the messages of all the users when the characters are displayed.

The display image data De is data for generating an image in which characters and backgrounds based on the messages received from the other users and the message stated by the user of the terminal apparatus 3 themselves are placed, and displaying the image on the display section 35.

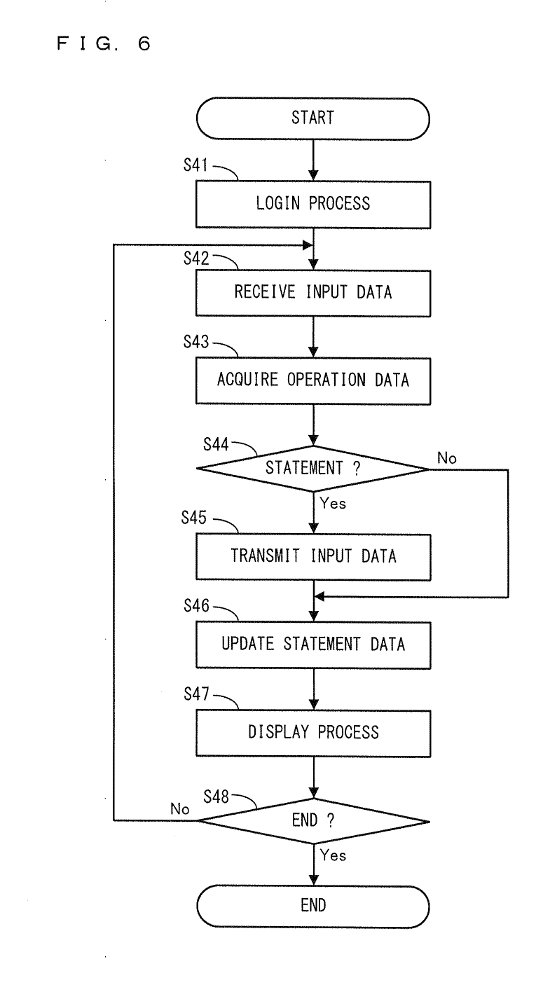

Next, with reference to FIG. 6, a detailed description is given of the processing performed by the terminal apparatus 3. It should be noted that FIG. 6 is a flow chart showing an example of the processing performed by the terminal apparatus 3. Here, in the flow chart shown in FIG. 6, descriptions are given mainly of, in the processing performed by the terminal apparatus 3, the process of exchanging messages among users, and the process of displaying the messages of the users. The detailed descriptions of other processes not directly related to these processes are omitted. Further, in FIG. 6, all the steps performed by the control section 31 are abbreviated as “S”.

The CPU of the control section 31 initializes a memory and the like of the storage section 32, and loads the display control program from the program storage section 33 into the memory. Then, the CPU starts the execution of the display control program. The flow chart shown in FIG. 6 is a flow chart showing the processing performed after the above processes are completed.

It should be noted that the processes of all the steps in the flow chart shown in FIG. 6 are merely illustrative. Thus, the processing order of the steps may be changed, or another process may be performed in addition to the processes of all the steps, so long as similar results are obtained. Further, in the exemplary embodiment, descriptions are given on the assumption that the control section 31 (the CPU) performs the processes of all the steps in the flow chart. Alternatively, a processor or a dedicated circuit other than the CPU may perform the processes of some or all of the steps in the flow chart.

Referring to FIG. 6, the control section 31 performs the process of logging into the network 100 (step 41), and proceeds to the subsequent step. For example, the control section 31 performs the process of logging into the network 100 using, for example, the user ID represented by the user ID data Db. Then, the application of a chat service provided via the network 100 is started, and the control section 31 performs the process of participating in the chat service. If there are users who have already been participating in the chat service at this time, information indicating that the user of the control section 31 has participated in the chat service may be transmitted to the already participating users.

Next, the control section 31 receives input data from other terminal apparatuses 3 via the network 100 (step 42), and proceeds to the subsequent step. Here, as will be apparent later, each terminal apparatus 3 transmits a user ID for identifying the user who is stating a message, and input data representing the message input by the user. For example, the input data transmitted from each terminal apparatus 3 includes character data representing the content of a message, statement date/time data representing the date and time of the statement of the message, and a user ID representing the user who has stated the message. The control section 31 updates the statement data Dd using the input data received from the other terminal apparatuses 3. It should be noted that, if it is immediately after the user of the terminal apparatus 3 has participated in the chat service, the input data representing the latest message at that time is transmitted from each of the other terminal apparatuses 3 that have already been participating in the chat service. Thus, the control section 31 receives the transmitted input data, and updates the statement data Dd.

Next, the control section 31 acquires operation data from the input section 34, updates the operation data Da (step 43), and proceeds to the subsequent step. It should be noted that, if the user is inputting the characters of a message to be subsequently stated, the control section 31 updates the input data Dc using the character data based on the input of the characters.

Next, the control section 31 determines whether or not the operation data acquired in the above step 43 is data representing the operation of stating a message (step 44). Then, if the operation data is data representing the operation of stating a message, the control section 31 proceeds to the subsequent step 45. If, on the other hand, the operation data is not data representing the operation of stating a message, the control section 31 proceeds to the subsequent step 46.

In step 45, the control section 31 transmits, to the other terminal apparatuses 3, input data representing the message subjected to the operation of stating it, and proceeds to the subsequent step 46. For example, as shown in FIG. 3, in a part of a display screen of the display section 35, there are provided a message creation area SA for writing a message to be stated to other users, and a statement button FB for transmitting a message written in the message creation area SA to state the message. Then, the user can write a message to be stated in the message creation area SA by operating the input section 34, and transmit the message written in the message creation area SA to the other terminal apparatuses 3 by selecting the statement button FB and making a determination. In accordance with the above operation, the control section 31 updates the input data Dc and the statement data Dd representing the statement made by the user of the terminal apparatus 3 themselves, using the character data representing the message written in the message creation area SA and the statement date/time data representing the date and time when the operation of stating the message has been performed. Further, the control section 31 transmits the character data and the statement date/time data, together with the user ID of the user of the terminal apparatus 3 themselves represented by the user ID data Db, to the other terminal apparatuses 3 participating in the same chat service. Further, the control section 31 updates the statement data Dd corresponding to the message stated by the user of the terminal apparatus 3 themselves, using the character data and the statement date/time data.

In step 46, the control section 31 changes and updates the states of the visual attributes of all the messages in accordance with the elapsed times of the respective messages, and proceeds to the subsequent step. For example, with reference to the statement data Dd, the control section 31 extracts the times and dates of the statements of the messages of all the users including the user of the terminal apparatus 3 themselves, and calculates the elapsed times of the respective messages. Then, the control section 31 changes the states of the visual attributes of all the messages on the basis of the set method of changing the visual attributes and the calculated elapsed times, and updates the statement data Dd.

Next, the control section 31 causes the latest messages of all the users including the user of the terminal apparatus 3 themselves to be displayed on the display section 35 on the basis of the statement data Dd (step 47), and proceeds to the subsequent step. For example, the control section 31 causes all the messages to be displayed on the display section 35 on the basis of the contents of the messages and the states of the visual attributes of the respective messages that are represented by the statement data Dd.

Next, the control section 31 determines whether or not to end the processing (step 48). Examples of conditions for ending the processing include: the satisfaction of the conditions under which the processing is ended (for example, time is over); the satisfaction of the conditions under which the game is completed; and the fact that the user has performed the operation of ending the processing. If the processing is not to be ended, the control section 31 returns to the above step 42, and repeats the process thereof. If the processing is to be ended, the control section 31 ends the processing indicated in the flow chart.

It should be noted that the above descriptions are given using the example where the terminal apparatus 3 performs the display control process. Alternatively, another apparatus may perform at least some of the processing steps of the display control process. For example, if the terminal apparatus 3 is further configured to communicate with another apparatus (for example, a server), said another apparatus may cooperate to perform the processing steps of the display control process. As a possible example, another apparatus may perform the process of aggregating statement data and changing the states of the visual attributes, and the terminal apparatus 3 may receive, from said another apparatus, data representing messages of all the users, and cause all the messages to be displayed on the display section 35 of the terminal apparatus 3. Another apparatus may thus perform at least some of the processing steps in the display control process, which enables a display control process similar to that described above. Further, the display control process described above can be performed by a processor or the cooperation of a plurality of processors, the processor and the plurality of processors contained in a display control system including at least one information processing apparatus.

In addition, the display control program may be supplied to the terminal apparatus 3 not only through an external storage medium, but also through a wired or wireless communication link. Further, the program may be stored in advance in a non-volatile storage device included in the terminal apparatus 3. It should be noted that examples of an information storage medium having stored therein the program may include CD-ROMs, DVDs, optical disk storage media similar to these, non-volatile memories, flexible disks, hard disks, magneto-optical disks, and magnetic tapes. Alternatively, an information storage medium having stored therein the program may be a volatile memory for storing the program. It can be said that such a storage medium is a storage medium readable by a computer or the like. For example, it is possible to provide the various functions described above by causing a computer or the like to load a program from the storage medium and execute it.

While some exemplary systems, exemplary methods, exemplary devices, and exemplary apparatuses have been described in detail above, the above descriptions are merely illustrative in all respects, and do not limit the scope of the systems, the methods, the devices, and the apparatuses. It is needless to say that the systems, the methods, the devices, and the apparatuses can be improved and modified in various manners without departing the spirit and scope of the appended claims. It is understood that the scope of the systems, the methods, the devices, and the apparatuses should be interpreted only by the scope of the appended claims. Further, it is understood that the specific descriptions of the exemplary embodiment enable a person skilled in the art to carry out an equivalent scope on the basis of the descriptions of the exemplary embodiment and general technical knowledge. It should be understood that, when used in the specification, the components and the like described in the singular with the word “a” or “an” preceding them do not exclude the plurals of the components. Furthermore, it should be understood that, unless otherwise stated, the terms used in the specification are used in their common meanings in the field. Thus, unless otherwise defined, all the jargons and the technical terms used in the specification have the same meanings as those generally understood by a person skilled in the art in the field of the exemplary embodiment. If there is a conflict, the specification (including definitions) takes precedence.

As described above, the exemplary embodiment is useful as, for example, a display control program, a display control apparatus, a display control system, a display control method, and the like in order, for example, to exchange character information among users.

What is claimed is:

1. A computer-readable storage medium having stored therein a display control program to be executed by a computer of an apparatus for performing display on a display apparatus, the display control program causing the computer to execute:
acquiring data including character information from another apparatus;
setting a visual attribute of, when at least characters representing the character information are displayed on the display apparatus, the characters by changing the visual attribute in accordance with an elapse of time; and
performing control so as to display the characters representing the character information on the display apparatus on the basis of the set visual attribute.

2. The computer-readable storage medium having stored therein the display control program according to claim 1, wherein
the visual attribute is set by changing the visual attribute such that, when displayed on the display apparatus, the characters become difficult to view in accordance with the elapse of time.

3. The computer-readable storage medium having stored therein the display control program according to claim 1, wherein
the visual attribute is set by: changing the visual attribute until a predetermined time elapses such that, when displayed on the display apparatus, the characters gradually become difficult to view at least with the characters being visible; and, after the predetermined time elapses, maintaining the visual attribute set at the elapse of the predetermined time.

4. The computer-readable storage medium having stored therein the display control program according to claim 1, wherein
a brightness of the characters when displayed on the display apparatus is set as the visual attribute by changing the brightness in accordance with the elapse of time, and
the characters representing the character information are displayed on the display apparatus on the basis of the set brightness.

5. The computer-readable storage medium having stored therein the display control program according to claim 1, wherein
a color of the characters when displayed on the display apparatus is set as the visual attribute by changing the color of the characters in accordance with the elapse of time, and
the characters representing the character information are displayed on the display apparatus on the basis of the set color of the characters.

6. The computer-readable storage medium having stored therein the display control program according to claim 1, wherein
a size of the characters when displayed on the display apparatus is set as the visual attribute by changing the size of the characters in accordance with the elapse of time, and
the characters representing the character information are displayed on the display apparatus on the basis of the set size of the characters.

7. The computer-readable storage medium having stored therein the display control program according to claim 1, wherein
a portion to be displayed with a first visual attribute and a portion to be displayed with a second visual attribute are set in each of the characters when displayed on the display apparatus, and a ratio of the portion to be displayed with the first visual attribute and the portion to be displayed with the second visual attribute is set by changing the ratio in accordance with the elapse of time, and
the characters representing the character information are displayed on the display apparatus on the basis of the first visual attribute, the second visual attribute, and the ratio that have been set.

8. The computer-readable storage medium having stored therein the display control program according to claim 1, wherein
the elapse of time is an elapse of time from a time when a user of said another apparatus inputs the character information to a present time.

9. The computer-readable storage medium having stored therein the display control program according to claim 1, the display control program further causing the computer to execute:
receiving an input from an input apparatus; and
inputting characters on the basis of the input, wherein
a visual attribute of the input characters when displayed on the display apparatus is also set by changing the visual attribute of the input characters in accordance with the elapse of time, and
the input characters are displayed on the display apparatus on the basis of the set visual attribute.

10. A display control apparatus for performing display on a display apparatus, the display control apparatus comprising:
a data acquisition unit for acquiring data including character information from another apparatus;
an attribute setting unit for setting a visual attribute of, when at least characters representing the character information are displayed on the display apparatus, the characters by changing the visual attribute in accordance with an elapse of time; and
a display control unit for displaying the characters representing the character information on the display apparatus on the basis of the set visual attribute.

11. A display control system, including a plurality of apparatuses configured to communicate with each other, for performing display on a display apparatus, the display control system comprising:
a data acquisition unit for acquiring data including character information from another apparatus;
an attribute setting unit for setting a visual attribute of, when at least characters representing the character information are displayed on the display apparatus, the characters by changing the visual attribute in accordance with an elapse of time; and
a display control unit for displaying the characters representing the character information on the display apparatus on the basis of the set visual attribute.

12. A display control method to be performed by a processor or a cooperation of a plurality of processors, the processor and the plurality of processors contained in a display control system including at least one information processing apparatus for performing display on a display apparatus, the display control method comprising:
acquiring data including character information from another apparatus;
setting a visual attribute of, when at least characters representing the character information are displayed on the display apparatus, the characters by changing the visual attribute in accordance with an elapse of time; and
performing control so as to display the characters representing the character information on the display apparatus on the basis of the set visual attribute.
